(19) United States
(12) Patent Application Publication
(10) Pub. No.: US 2024/0367480 A1
(43) Pub. Date: Nov. 7, 2024

(54) CAB HEATER SYSTEMS FOR BATTERY ELECTRIC VEHICLES

(71) Applicant: Cummins Inc., Columbus, IN (US)

(72) Inventor: Mark N. Bays, Columbus, IN (US)

(21) Appl. No.: 18/651,228

(22) Filed: Apr. 30, 2024

Related U.S. Application Data
(60) Provisional application No. 63/464,420, filed on May 5, 2023.

(51) Int. Cl. B60H 1/00; B60H 1/22; B60L 1/02; F28D 20/00

(52) U.S. Cl. CPC B60H 1/00392; B60H 1/2209; B60H 1/2212; B60H 1/2225; B60L 1/02; B60H 1/00371; B60H 2001/224; B60H 2001/2271; B60H 2001/2284; F28D 20/003

(57) ABSTRACT

The present disclosure provides cab heater systems for electric vehicles. The first system includes a combustion chamber having a combustor inlet, a combustor outlet, and a hydrogen storage fluidly coupled to the combustor inlet configured to supply hydrogen to the combustor for combustion. The second system includes a fluid circulation pump, one or more cabin heat exchangers, a heat transfer tube fluidly connected to the fluid circulation pump and to the one or more cabin heat exchangers, and an insulated tank. The insulated tank includes a tank heat exchanger fluidly connected to the heat transfer tube, a resistance heater, and a phase change material. In the charging mode, the resistance heater provides heat to the phase change material and to the tank heat exchanger, while in the heating mode, the fluid circulation pump provides heat to the tank heat exchanger and to the one or more cabin heat exchangers.

### CROSS-REFERENCE TO RELATED PATENT APPLICATIONS

The present application claims the benefit of priority U.S. Provisional Patent Application No. 63/464,420, filed May 5, 2023, the content of which is incorporated herein by reference in its entirety.

### FIELD OF THE DISCLOSURE

The present disclosure relates to systems and methods for providing cab heat to a vehicle, and more specifically, to systems and methods for providing cab heat using phase change materials and hydrogen.

### BACKGROUND OF THE DISCLOSURE

In temperate climates, a vehicle battery is sized to provide enough energy for the vehicle to traverse a particular range. In climates with colder weather, a larger battery may be needed to account for a loss of range due to the colder temperatures. The reduction in range results from additional energy being drawn from the battery to provide cab heat to the vehicle. Cab heat is provided to the batteries (for optimal operation of the batteries), to the cabin space (to provide comfort to the passengers of the vehicle), and to other vehicle components that have an optimal operating temperature (such as traction inverters). For vehicles with larger cabins, such as buses, more energy might be needed to keep the larger cabin space and the batteries at room temperature, resulting in the need for larger batteries to provide additional heating capacity. This poses a problem where vehicles are fitted with batteries that are larger than needed for ordinary vehicle functions, besides the thermal management system, such as providing traction to the wheels and controlling accessories. The larger batteries increase the production costs and the weight of the vehicle, which in turn, increases the total cost of ownership for the end customer.

### SUMMARY

The present disclosure provides cab heater systems for electric vehicles. A first aspect of the present disclosure provides a hydrogen combustor for providing cab heat to an electric vehicle. The hydrogen combustor includes a combustion chamber having a combustor inlet, a combustor outlet, and a hydrogen storage fluidly coupled to the combustor inlet configured to supply hydrogen to the combustor for combustion. In some embodiments, the hydrogen combustor may further include a burner for igniting the hydrogen within the combustion chamber to produce heat. In some embodiments, the hydrogen combustor may further include a heat exchanger, and the heat produced by combusting hydrogen is transferred to a quantity of air via the heat exchanger.

In some embodiments, the hydrogen combustor may further include a blower, which draws air into the combustion chamber through the combustor inlet to facilitate the transfer of heat from the heat exchanger to the quantity of air. In some embodiments, the heat exchanger may include a plurality of fins or baffles for increasing the surface area available for heat transfer. In some embodiments, the burner and heat exchanger may be integrated into a single unit for compactness and ease of installation. In some embodiments, the hydrogen combustor may further include a radiator having a liquid flowing through the coils of the radiator, such that the heat produced by combusting hydrogen is transferred to the liquid flowing through the coils of the radiator, and a quantity of air absorbs the heat from the liquid flowing through the radiator coils.

A second aspect of the present disclosure provides a method of providing cab heat to an electric vehicle. The method includes combusting hydrogen to create heat, creating warm air by allowing a flow of air to absorb the heat, and providing the warm air to the electric vehicle. In some embodiments, the method may further include positioning a heat exchanger downstream from the hydrogen being combusted and creating warm air by allowing the flow of air to absorb heat from the heat exchanger. In some embodiments, the heat exchanger may transfer heat to the cabin using a liquid that flows through a heater core located in the cabin. In some embodiments, the heat produced by combusting hydrogen is transferred to a liquid flowing through the coils of a radiator, and a quantity of air absorbs the heat from the liquid flowing through the radiator coils.

A third aspect of the present disclosure provides a system for providing cab heat to an electric vehicle. The system includes a fan, an electric heater positioned downstream from the fan, a vehicle battery for providing power to the electric heater and the fan, and a hydrogen combustor positioned downstream from the fan. The hydrogen combustor includes a combustion chamber having a combustor inlet and a combustor outlet, a hydrogen storage fluidly coupled to the combustor inlet configured to supply hydrogen to the combustor for combustion, and a burner for igniting the hydrogen within the combustion chamber to produce heat. In some embodiments, the system may further include a hydrogen supply line for supplying hydrogen from the hydrogen storage tank to the combustion chamber. In some embodiments, the system may further include a heat exchanger for transferring heat from the hydrogen combustion to the air.

In some embodiments, the system may further include a radiator having a liquid flowing through the coils of the radiator, such that the heat produced by combusting hydrogen is transferred to the liquid flowing through the coils of the radiator, and a quantity of air absorbs the heat from the liquid flowing through the radiator coils. In some embodiments, the system may further include a controller configured to deactivate the hydrogen combustor when the cabin temperature reaches a predetermined threshold. In some embodiments, the system may further include a controller to regulate the rate of hydrogen combustion and the flow rate of air through the heat exchanger to maintain a desired cabin temperature. In some embodiments, the combustor and heat exchanger may be integrated into a single unit for compactness and case of installation. In some embodiments, the hydrogen is stored in a high-pressure tank or a solid-state hydrogen storage material.

A fourth aspect of the present disclosure provides a system for providing heat to the cabin of an electric vehicle. The system includes a fluid circulation pump, one or more cabin heat exchangers, a heat transfer tube fluidly connected to the fluid circulation pump and to the one or more cabin heat exchangers, and an insulated tank. The insulated tank includes a tank heat exchanger fluidly connected to the heat transfer tube, a resistance heater, and a phase change material. In the charging mode, the resistance heater provides heat to the phase change material and to the tank heat exchanger. In the heating mode, the fluid circulation pump circulates a heat transfer fluid through the heat transfer tube to the tank heat exchanger, where heat from the tank heat exchanger is absorbed by the heat transfer fluid. In the heating mode, the fluid circulation pump also circulates a heat transfer fluid through the heat transfer tube to the one or more cabin heat exchangers, where heat from the heat transfer fluid is absorbed by ambient air in the cabin.

In some embodiments, the system may further include one or more batteries and an electrical connection, and the electrical connection provides electricity to the resistance heater and to the batteries. In some embodiments, the insulated tank may further include a sensor for detecting when the phase change material changes from a first phase to a second phase, and the electrical connection may automatically stop the flow of electricity to the resistance heater when the phase change material changes from the first phase to the second phase. In some embodiments, the one or more cabin heat exchangers may include blowers for drawing ambient air into the one or more cabin heat exchangers, so as to maximize the transfer of thermal energy from the heat transfer fluid to the ambient air. In some embodiments, the heat transfer fluid may be water. In other embodiments, the heat transfer fluid may be glycol. In some embodiments, the heat transfer fluid may be a refrigerant. In some embodiments, the phase change material may be a thermochemical material. In some embodiments, the thermochemical material may be TCM-71.

A fifth aspect of the present disclosure provides a system for providing heat to the cabin of an electric vehicle. The system includes a powertrain operationally coupled to a power source and a tank containing a heating material separate from the power source. In some embodiments, the heating material is one of hydrogen and a phase change material. In some embodiments, the system further includes a heat exchanger thermally coupled to the tank.

While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is a schematic diagram of a battery electric vehicle, in accordance with embodiments of the present disclosure;

FIG. 2 is a block diagram of an example vehicle having a vehicle cab heater, in accordance with embodiments of the present disclosure;

FIG. 3 is a block diagram of an exemplary battery-powered vehicle using a diesel combustor to provide cab heat, in accordance with embodiments of the present disclosure;

FIG. 4 is a block diagram of an exemplary battery-powered vehicle using a hydrogen combustor to provide cab heat, in accordance with embodiments of the present disclosure;

FIG. 5 is an illustration of an exemplary hydrogen combustor, in accordance with embodiments of the present disclosure;

FIG. 6 is a schematic diagram of an example vehicle having a cabin heat system, in accordance with embodiments of the present disclosure;

FIG. 7 depicts a flowchart of an example method for selecting between modes of providing cab heat to an electric vehicle, in accordance with embodiments of the present disclosure; and

FIG. 8 is a block diagram of an example computing device that may be used in accordance with embodiments of the present disclosure.

Corresponding reference characters indicate corresponding parts throughout the several views. The exemplifications set out herein illustrate exemplary embodiments of the disclosure and such exemplifications are not to be construed as limiting the scope of the disclosure in any manner.

### DETAILED DESCRIPTION

For the purposes of promoting an understanding of the principles of the present disclosure, reference is now made to the embodiments illustrated in the drawings, which are described below. The exemplary embodiments disclosed herein are not intended to be exhaustive or to limit the disclosure to the precise form disclosed in the following detailed description. Rather, these exemplary embodiments were chosen and described so that others skilled in the art may utilize their teachings.

The terms “couples,” “coupled,” and variations thereof are used to include both arrangements wherein two or more components are in direct physical contact and arrangements wherein the two or more components are not in direct contact with each other (e.g., the components are “coupled” via at least a third component), but yet still cooperate or interact with each other. Furthermore, the terms “couples,” “coupled,” and variations thereof refer to any connection for machine parts known in the art, including, but not limited to, connections with bolts, screws, threads, magnets, electro-magnets, adhesives, friction grips, welds, snaps, clips, etc.

Throughout the present disclosure and in the claims, numeric terminology, such as first and second, is used in reference to various components or features. Such use is not intended to denote an ordering of the components or features. Rather, numeric terminology is used to assist the reader in identifying the component or features being referenced and should not be narrowly interpreted as providing a specific order of components or features.

One of ordinary skill in the art will realize that the embodiments provided can be implemented in hardware, software, firmware, and/or a combination thereof. Programming code according to the embodiments can be implemented in any viable programming language such as C, C++, HTML, XTML, JAVA or any other viable high-level programming language, or a combination of a high-level programming language and a lower level programming language.

The present disclosure relates to systems and methods for providing cab heat to a vehicle. A vehicle, such as a battery electric vehicle, diesel hybrid vehicle, or a fuel cell electric vehicle, includes a power supply to provide electrical power to a powertrain of the vehicle to drive/propel the vehicle. In addition to providing power for regular vehicle functions, such as creating traction at the wheels and powering vehicle accessories, additional power might be needed to provide cab heat to the vehicle. This is because batteries work best when they operate at temperatures close to room temperature. Typically, the batteries of an electric vehicle achieve this temperature by warming themselves using internally generated heat. However, it might be necessary to provide additional cab heat to help the batteries reach room temperature, such as when the vehicle initially starts up on cold days.

In addition, cab heat is useful for maintaining the temperature of the cabin at about room temperature to provide comfort to its passengers. In climates where temperatures range from very hot (e.g., above 90 deg. F.) to very cold (e.g., below −40 deg. F.), fitting a vehicle with the right size of battery may be difficult because energy demands on the battery may vary widely depending on the time of year.

To address these and other challenges, one aspect of the present disclosure is directed to a vehicle cab heater system which uses hydrogen as a fuel source for a combustor to provide cab heat. Another aspect of the present disclosure is directed to a vehicle cab heater system which uses phase change materials to convert electricity into latent heat energy for later use to provide cab heat. In some embodiments, the cab heater systems may draw power from the batteries to enable conventional resistive heating, while in other embodiments, the cab heater may use a combination of one or more sources to create cab heat. By using these different sources of energy for creating cab heat, embodiments of the present disclosure are able to be more responsive to temperature demands without the need for an over-sized battery. The present disclosure also includes a method for selecting between these various modes of providing cab heat to an electric vehicle.

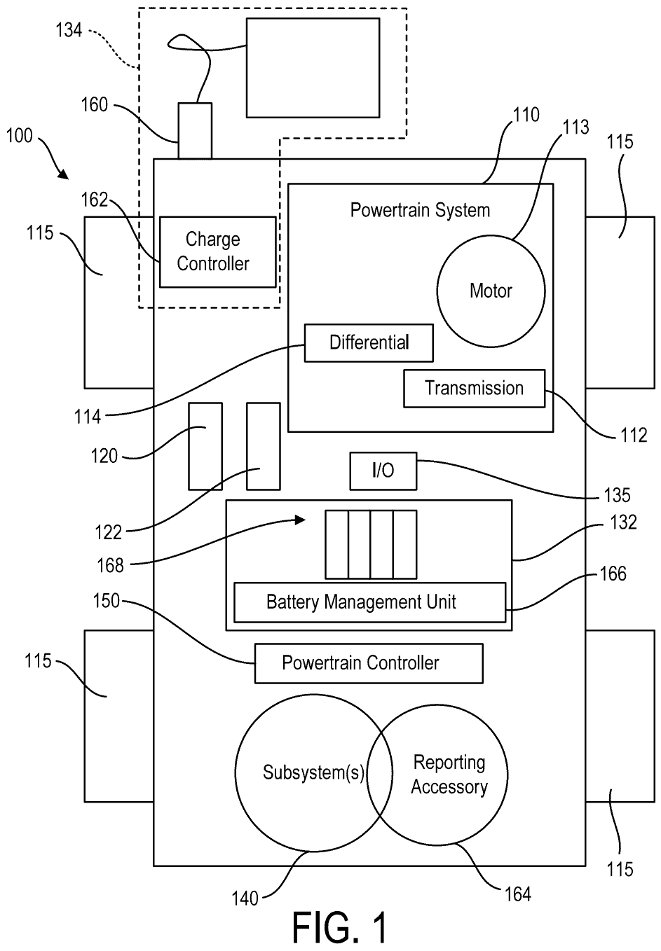

Referring initially to FIG. 1, a schematic diagram of a battery electric vehicle 100 is provided. While the vehicle is referred to as a battery electric vehicle, it is understood that the vehicle may include a hybrid vehicle, such as a plug-in hybrid vehicle, powered or otherwise operable via a battery and, optionally, one or more of a generator (e.g., a power generator, generator plant, electric power strip, on-board rechargeable electricity storage system, etc.) and a motor (e.g., an electric motor, traction motor, etc.). Battery electric vehicle 100 may be operable in at least one of a reverse direction (e.g., a backward direction relative to a front end of battery electric vehicle 100) and a non-reverse direction (e.g., a forward direction, angular direction, etc., relative to the front end of battery electric vehicle 100). Battery electric vehicle 100 may be an on-road or off-road vehicle including, but not limited to, cars, trucks, ships, boats, vans, airplanes, spacecraft, or any other type of vehicle.

Battery electric vehicle 100 comprises a powertrain controller 150 communicably and operatively coupled to a powertrain system 110, a brake mechanism 120, an accelerator pedal 122, one or more sensors, an operator input/output (I/O) device 135, and one or more additional vehicle subsystems 140. Battery electric vehicle 100 may include additional, fewer, and/or different components systems than depicted in FIG. 1, such that the principles, methods, systems, apparatuses, processes, and the like of the present disclosure are intended to be applicable with any suitable vehicle configuration. It should also be understood that the principles of the present disclosure should not be interpreted to be limited to on-highway vehicles; rather, the present disclosure contemplates that the principles may also be applied to a variety of other applications including, but not limited to, off-highway construction equipment, mining equipment, marine equipment, locomotive equipment, etc.

Powertrain system 110 facilitates power transfer from a battery 132 and/or a motor 113 to power battery electric vehicle 100. In an exemplary embodiment, powertrain system 110 includes motor 113 operably coupled to battery 132 and charge system 134, where motor 113 transfers power to a final drive (e.g., wheels 115) to propel battery electric vehicle 100. As depicted, powertrain system 110 may include other various components, such as a transmission 112 and/or differential 114, where differential 114 transfers power output from transmission 112 to final drive 115 to propel battery electric vehicle 100. Powertrain controller 150 of battery electric vehicle 100 provides electricity to motor 113 (e.g., an electric motor) in response to various inputs received by powertrain controller 150, for example, from accelerator pedal 122, sensors, vehicle subsystems 140, charge system 134 (e.g., a battery charging system, rechargeable battery, etc.). In some embodiments, electricity provided to power motor 113 may be provided by an onboard gasoline-engine generator, a hydrogen fuel cell, etc.

In some embodiments, battery electric vehicle 100 may include transmission 112. Transmission 112 may be structured as any type of transmission compatible with battery electric vehicle 100, including a continuous variable transmission, a manual transmission, an automatic transmission, an automatic-manual transmission, or a dual clutch transmission, for example. Accordingly, as transmissions vary from geared to continuous configurations, transmission 112 may include a variety of settings (e.g., gears, for a geared transmission) that affect different output speeds based on an engine speed or motor speed. Like transmission 112, motor 113, differential 114, and final drive 115 may be structured in any configuration compatible with battery electric vehicle 100. In some embodiments, transmission 112, is omitted and motor 113 is directly coupled to differential 114. In other embodiments, motor 113 is directly coupled to final drive 115 as a direct drive application. In some examples, battery electric vehicle may comprise multiple instances of motor 113, for example, one instance for each driven wheel, one instance per driven axle, or other compatible arrangements.

Brake mechanism 120 may be implemented as a brake (e.g., hydraulic disc brake, drum brake, air brake, etc.), braking system, or any other device configured to prevent or reduce motion by slowing or stopping components (e.g., a wheel, axle, pedal, crankshaft, driveshaft, etc. of battery electric vehicle 100). Generally, brake mechanism 120 is configured to receive an indication of a desired change in the vehicle speed. In some embodiments, brake mechanism 120 comprises a brake pedal operable between a released state and an applied state by an operator of battery electric vehicle 100. The brake pedal may be configured as a pressure-based system responsive to applied pressure or a travel-based system responsive to a travel distance of the pedal, where a force applied to brake mechanism 120 is proportional to the pressure and/or travel distance. In some embodiments, all or a portion of brake mechanism 120 is incorporated into motor 113, for example, as a regenerative brake mechanism.

Generally, the released state of brake mechanism 120 corresponds to a brake pedal in a default location where the brake mechanism is not applied, for example, when the operator's foot is not placed on the brake pedal at all, or merely resting on the brake pedal such that a minimum actuation force is not exceeded (e.g., a spring-assisted, hydraulic-assisted, or servo-assisted force that pushes the brake pedal to the default location). In some embodiments, the brake pedal is combined with accelerator pedal 122 in a one-pedal driving configuration. In some examples, the applied state of brake mechanism 120 may correspond to the brake pedal being pressed with a force that meets or exceeds the minimum actuation force. In other examples, the applied state of brake mechanism 120 corresponds to the brake pedal being pressed so that the travel distance of the brake pedal meets or exceeds a minimum travel distance. Generally, the minimum actuation force and/or minimum travel distance help to prevent accidental actuation of brake mechanism 120. Different levels of the minimum actuation force and/or minimum travel distance may be used for different implementations of brake mechanism 120, for example, relatively higher forces or travel distance for a foot-actuated brake pedal, relatively lower forces or travel distance for a hand-actuated brake lever. Although the brake pedal may have a range of pressures and/or travel distances that provide at least some braking effect on battery electric vehicle 100 (e.g., high pressures for hard or emergency braking, low pressures for gradual braking or “feathering” the brakes), this range of pressures and/or travel distances are within the applied state.

The released state may correspond to an indication of a desired increase in vehicle speed, while the applied state may correspond to an indication of a desired reduction in vehicle speed. In some embodiments, a reduction in actuation force and/or travel distance corresponds to a desired increase in vehicle speed, while an increase in actuation force and/or travel distance corresponds to a desired reduction in vehicle speed.

Accelerator pedal 122 may be structured as any type of torque and/or speed request device included with a system (e.g., a floor-based pedal, an acceleration lever, paddle or joystick, etc.). Sensors associated with accelerator pedal 122 and/or brake mechanism 120 may include a vehicle speed sensor that provides a vehicle speed signal corresponding to a vehicle speed of battery electric vehicle 100, an accelerator pedal position sensor that acquires data indicative of a depression amount of the pedal (e.g., a potentiometer), a brake mechanism sensor that acquires data indicative of a depression amount (pressure or travel) of brake mechanism 120, a coolant temperature sensor, a pressure sensor, an ambient air temperature, or other suitable sensors.

Battery electric vehicle 100 may include operator I/O device 135. Operator I/O device 135 may enable an operator of the vehicle to communicate with battery electric vehicle 100 and/or powertrain controller 150. Analogously, operator I/O device 135 enables battery electric vehicle 100 and/or powertrain controller 150 to communicate with the operator. For example, operator I/O device 135 may include, but is not limited to, an interactive display (e.g., a touchscreen) having one or more buttons, input devices, haptic feedback devices, an accelerator pedal, a brake pedal, a shifter or other interface for transmission 112, a cruise control input setting, a navigation input setting, or other settings or adjustments available to the operator. Via operator I/O device 135, powertrain controller 150 can also provide commands, instructions, and/or information to the operator or a passenger.

Battery electric vehicle 100 includes one or more vehicle subsystems 140, which may generally include one or more sensors (e.g., a speed sensor, ambient pressure sensor, temperature sensor, etc.), as well as any other subsystem that may be included with a vehicle. Vehicle subsystems 140 may also include torque sensors for one or more of motor 113, transmission 112, differential 114, and/or final drive 115. Other vehicle subsystems 140 may include a steering subsystem for managing steering functions, such as electrical power steering, and output information such as wheel position and fault codes corresponding to steering battery electric vehicle 100; an electrical subsystem which may include audio and visual indicators, such as hazard lights and speakers configured to emit audible warnings, as well as other functions; and a thermal management system, which may include components such as a radiator, coolant, pumps, fans, heat exchangers, computing devices, and associated software applications. Battery electric vehicle 100 may include further sensors other than those otherwise discussed herein, such as cameras, LIDAR, and/or RADAR, temperature sensors, smoke detectors, virtual sensors, among other potential sensors.

Powertrain controller 150 may be communicably and operatively coupled to powertrain system 110, brake mechanism 120, accelerator pedal 122, operator I/O device 135, and one or more vehicle subsystems 140. Communication between and among the components may be via any number of wired or wireless connections. For example, a wired connection may include a serial cable, a fiber optic cable, an SAE J1939 bus, a CAT5 cable, or any other form of wired connection. In comparison, a wireless connection may include the Internet, Wi-Fi, Bluetooth, Zigbee, cellular, radio, etc. In one embodiment, a controller area network (CAN) bus including any number of wired and wireless connections provides the exchange of signals, information and/or data. Powertrain controller 150 is structured to receive data (e.g., instructions, commands, signals, values, etc.) from one or more of the components of battery electric vehicle 100 as described herein via the communicable coupling of powertrain controller 150 to the systems and components of battery electric vehicle 100. In some embodiments, an additional or alternative controller may be used for receiving data from certain systems or components.

In vehicles including charge system 134, such as a plug-in charging system, battery electric vehicle 100 may powertrain controller 150 may control charging of battery 132 when a charger 160 of charge system 134 is connected to battery electric vehicle 100. A charge controller 162 establishes communications between powertrain controller 150 and charger 160. Charge controller 162 may receive a charge command from powertrain controller 150 and charger 160. Charge controller 162 may monitor sensor signals and perform safety and performance checks and determine faults based thereon. For example, charge controller 162 may determine a fault if charging has started but a physical connection between charger 160 and battery electric vehicle 100 fails to be detected or is detected to be outside safe boundaries. In other words, charge controller 162 may function as a communication interface between charger 160 and powertrain controller 150.

Powertrain controller 150 may be communicably coupled with charger 160, battery 132 and a reporting accessory 164 so that digital data may be transferred between components. Reporting accessory 164 may be include a vehicle subsystem 140 or another vehicle component. A CAN bus may be implemented to provide communications. In some embodiments, a first CAN bus may be implemented to provide communications between a first plurality of components while a second CAN bus may be implemented to provide communications between a second plurality of components. Any series or parallel communication scheme and protocol known in the arm may be implemented to provide communication.

Reporting accessory 164 may be operable to communicate information to powertrain controller 150. Such information may include identification, current demand, high or low voltage power draw, and other information required for operation of battery electric vehicle 100. Identification information may include a maximum current capacity of reporting accessory 164, for example. The current demand may be dynamic, such that the current demanded by reporting accessory 164 varies. Reporting accessory 164 may include an air-conditioning system, for example, and the current demand may vary based on a measured actual temperature of an interior of battery electric battery 100 compared to a target temperature. By reporting current demand to powertrain controller 150, reporting accessory 164 enables powertrain controller 150 to more accurately determine the target current to generate the charge command to charger 162. Comparatively, when the load of a non-reporting accessory is dynamic and unknown, charger 162 may under deliver current to battery 132, extending charging time. The charge command may also take into account the charger's capability to deliver current and indicates to charger 162 the level of current to output to battery electric vehicle 100, which is ideally sufficient to optimally charge battery 132 and also power the accessories.

Battery 132 may include one or more battery packs including a battery management unit 166 and battery modules 168. FIG. 1 is not determinative of the number of battery modules within a battery pack or the number of battery packs within battery 132. Battery 132 may include a greater number of battery packs and/or a greater or lesser number of battery modules. Temperature, voltage, and other sensors may be provided to enable battery management unit 166 to manage the charging and discharging of battery modules 168 without exceeding their limits, to detect and manage faults, and to perform other known functions. Battery management unit 166 may transmit data to powertrain controller 150 related to information about battery 132, including the battery charge power limit, temperature, faults, etc. Battery 132 may include a current sensor to provide a measured current value to battery management unit 166, which may be used to affect the charge command provided to charger 162. The current sensor may be located elsewhere. Multiple current sensors may be used, each current sensor associated with a battery module of battery 132, where the sum of the measured currents being the measured current of battery 132.

Powertrain controller 150 may include a charge logic operable to determine a command for charger 162 to supply a target current to battery 132. The charge logic may also be integrated with a controller of battery management unit 166 or provided in a standalone controller communicatively coupled to powertrain controller 150. The term “logic” as used herein includes software and/or firmware comprising processing instructions executing on one or more programmable processors, application-specific integrated circuits, field-programmable gate arrays, digital signal processors, hardwired logic, or combinations thereof, which may be referred to as “controllers”. Therefore, in accordance with the disclosure, various logic may be implemented in any appropriate fashion. A non-transitory machine-readable medium comprising logic can additionally be included within any tangible form of a computer-readable carrier, such as a solid-state memory, containing an appropriate set of computer instructions and data structures that would cause a processor to carry out the techniques described herein. A non-transitory computer-readable medium, or memory, may include random access memory (RAM), read-only memory (ROM), erasable programmable read-only memory (e.g., EPROM, EEPROM, or Flash), or any tangible medium capable of storing information.

A transport control system and charging system may communicatively connect multiple chargers and control charging processes in a depot, linking charging points, power supplies, and operational information systems, such as planning and scheduling systems. The transport control system may provide the charging management system information such as estimated arrival time of vehicles, time available for charging, and scheduled pull-out time. The charging management system can then calculate the charging requirements for each vehicle and optimize charging processes for the fleet of vehicles to, for example, avoid expensive grid peak load periods where possible. The charging management system may also assign time slots for charging to each vehicle and monitor the progress of charging of each vehicle. The charging management system may receive from each vehicle an estimated time to full charge. In other embodiments, the vehicle may provide the relevant data to the charging management system, which may then estimate the time to full charge within its control logic.

Although FIG. 1 is described as illustrating a battery electric vehicle, the disclosure provided herein may also apply to vehicles having other powertrains, such as, for example, a plug-in hybrid vehicle. In such embodiments, the vehicle optionally includes an engine which may be structured as an internal combustion engine that receives a chemical energy input (e.g., a fuel such as natural gas, gasoline, ethanol, or diesel) from a fuel delivery system, and combusts the fuel to generate mechanical energy, in the form of a rotating crankshaft. In such an embodiment, transmission receives the rotating crankshaft and manipulates the speed of the crankshaft (e.g., the engine speed, which is usually expressed in revolutions-per-minute (RPM)) to affect a desired draft shaft speed. A rotating drive shaft may be received by differential, which provides the rotation energy from the drive shaft to final drive, which then propels or moves the vehicle.

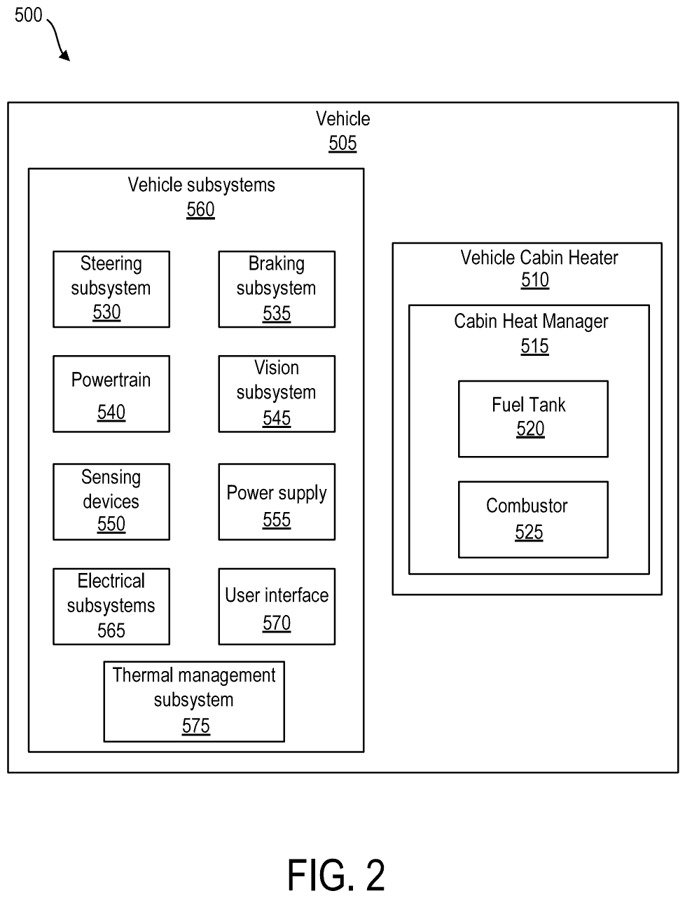

FIG. 2 illustrates a system 500 that includes a vehicle 505, such as a battery electric vehicle, diesel hybrid vehicle, or a fuel cell electric vehicle. Vehicle 505 includes a set of vehicle subsystems 560 that can perform a plurality of tasks. For example, steering subsystem 530 manages steering functions, such as electrical power steering, and output information such as wheel position and fault codes corresponding to steering the vehicle 505. Braking subsystem 535 manages braking functions of the vehicle, such as regenerative braking and friction braking. Braking subsystem 535 further outputs information regarding vehicle braking. Powertrain 540 includes components that propel the vehicle, such as engine, transmission, motor generators, etc.

Powertrain 540 may further output information regarding the operation of such components. Vision subsystem 545 may include one or more sensors (e.g., cameras, LIDAR, and/or RADAR) that detect and output data regarding the relative position of the vehicle 505 to other objects, such as other vehicles. Sensing devices 550 may include one or more temperature sensors, smoke detectors, virtual sensors, etc., and may output information regarding a temperature or condition of power supply 555. Power supply 555 may include components such as a high voltage battery, a hydrogen source, etc. Electrical subsystems 565 may include audio and visual indicators, such as hazard lights and speakers configured to emit audible warnings. User interface 570 may include a display configured to permit a user to input information and to receive communications regarding the vehicle 505.

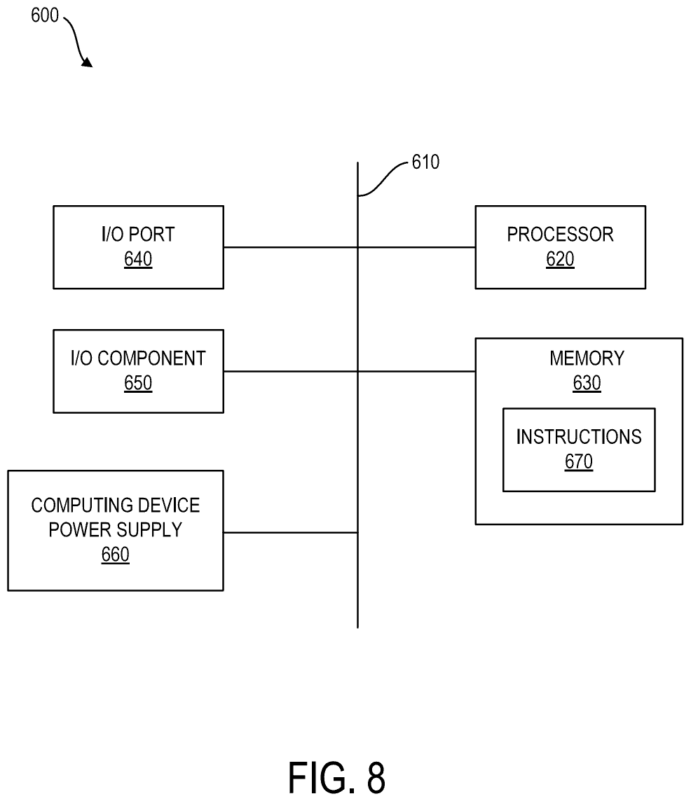

Thermal management system 575 includes components to cool the power supply 555 and/or other vehicle components. Thermal management system 575 may include components such as a radiator, coolant, pumps, fans, heat exchangers etc. Thermal management system 510 may include a software application for managing the operation of vehicle subsystems 560. Thermal management system 575 and vehicle subsystems 560 may include a computing device, such as computing device 600 discussed with respect to FIG. 8.

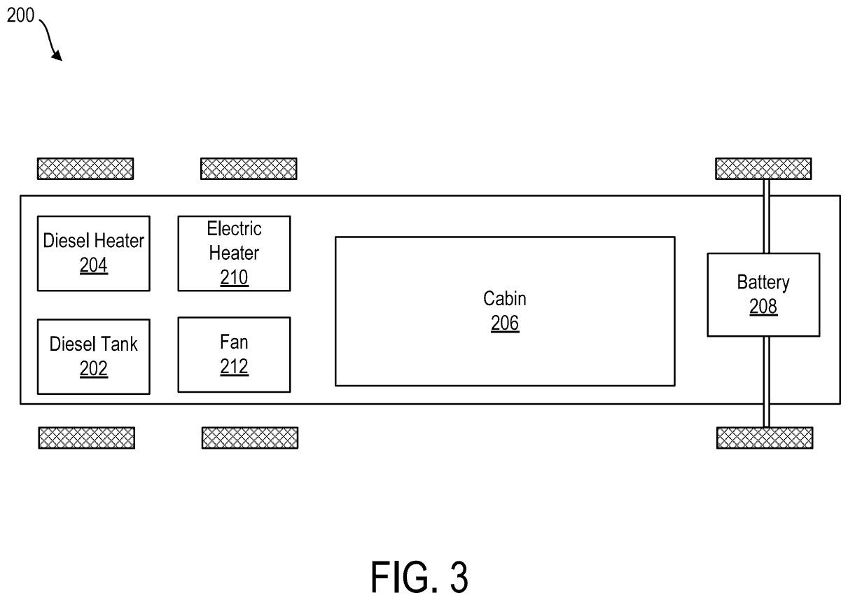

FIG. 3 is a block diagram of a battery-powered vehicle 200 with a convention diesel cab heater, including a diesel tank 202, a diesel combustor 204, a cabin 206, a battery 208, an electric heater 210, and a fan 212. During normal operation, power is supplied to an electric heater 210 from a battery 208 to generate heat. The electric heater 210 includes a heating element situated in the ventilation system downwind of the fan 212. The heating element of the electric heater 210 receives electric current from the battery 208 and converts that electric current into heat through resistive heating. Resistive heating occurs when electric current through the element encounters resistance, producing heat. A fan 212 is located downwind of the electric heater 210 and generates a flow of air through the cabin 206.

In colder climates when temperatures drop close to, or below, freezing, an electric resistance heater might be unable to provide a sufficient amount of cab heat to an electric vehicle. In these situations, a conventional diesel cab heater may provide additional heat to ensure comfort of the passengers in the cabin 206. In operation, diesel tank 202 provides diesel to a diesel combustor 204 which combusts the diesel producing heat as well as by-products, such as methane (CH4), oxides of nitrogen (NO and N2O), and carbon dioxide (CO2). These by-products need to be safely treated to avoid harmful emissions being exposed to the atmosphere or to the passengers in the cabin. To do this, aftertreatment systems, such as diesel particulate filters, diesel oxidation catalysts, and selective catalytic reduction systems, are used to convert oxides of nitrogen and methane into water (H20) and molecular nitrogen (NO2). However, CO2, another by-product which is also a greenhouse gas, cannot be removed by aftertreatment. Production of carbon dioxide by a diesel cab heater defeats the purpose of an environmentally friendly battery-powered vehicle.

Turning back to FIG. 3, heat is produced in the diesel combustor 204 and a fan 212 positioned downstream from the combustor generates a flow of air. This flow of air absorbs thermal energy as it flows through the diesel combustor 204 and exits the diesel combustor 204 at an elevated temperature. The warm air then flows through the vehicle 200 providing additional cab heat. Utilizing a diesel combustor 204 for additional heat during colder temperatures allows for the vehicle 200 to be sized with a smaller battery 208 because the diesel combustor 204 removes the need for additional current to be drawn from the battery 208.

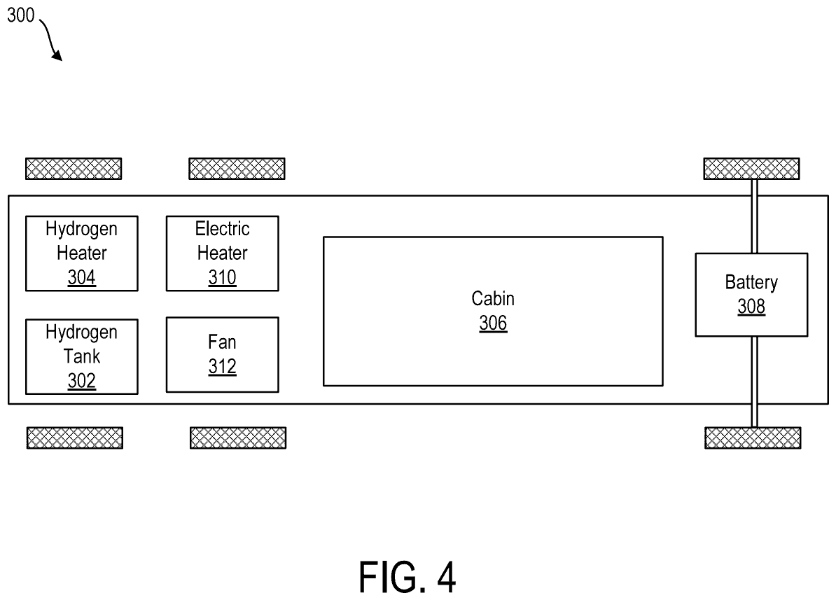

FIG. 4 is a block diagram of a battery-powered vehicle 300 with a hydrogen cab heater, including a hydrogen tank 302, a hydrogen combustor 304, a cabin 306, a battery 308, an electric heater 310, and a fan 312. In some embodiments, heat is generated by resistive heating during normal temperature ranges (e.g., between 40 deg F. to 70 deg F.). During periods with colder temperatures (e.g., less than 40 deg F.), the hydrogen tank 302 supplies the hydrogen combustor 304 with hydrogen for combustion to provide cab heat. The fan 212 generates a flow of air which circulates the heat generated by the hydrogen combustor 304 through the cabin 306 to the battery 308 and other components of the vehicle. Combustion of hydrogen produces water as the only by-product, so there is no need for a costly aftertreatment system. Additionally, utilizing a hydrogen combustor 304 allows the vehicle to be sized with a smaller battery, thereby reducing the cost of manufacturing these vehicles.

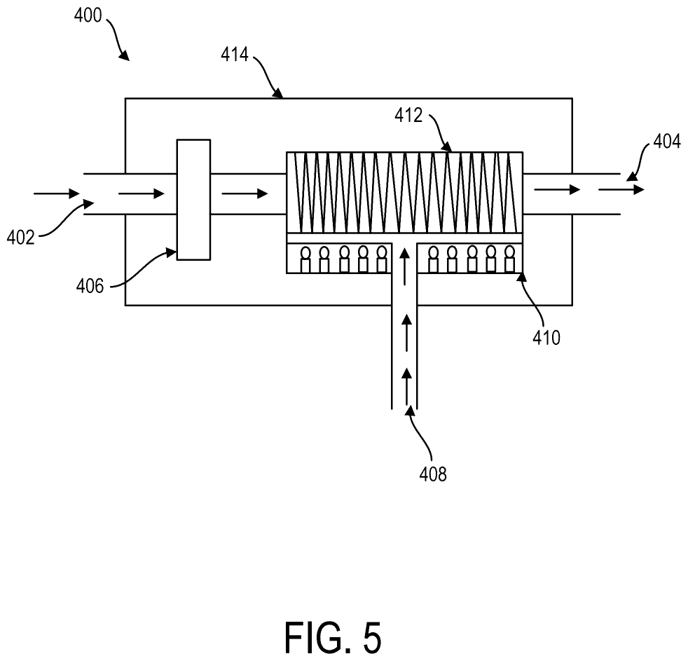

FIG. 5 illustrates an exemplary hydrogen combustor 400 comprising a combustor inlet 402, a combustor outlet 404, and a combustion chamber 414. Ambient air flows into the combustion chamber 414 through the combustor inlet 402 and the air absorbs heat generated inside the combustion chamber 414. As the temperature of the air increases, it exits hydrogen combustor 400 through combustor outlet 404 and is supplied to the rest of the vehicle 200 through air ducts. The combustion chamber 414 includes a blower 406, a burner 410, and a heat exchanger 412. The heat exchanger has a large surface area which increases the rate of heat transfer through conduction to the air as well as through radiation.

In operation, the blower 406 pulls fresh air from outside the vehicle 200 and into the combustion chamber 414 through the combustor inlet 402. As hydrogen is supplied to the combustion chamber 414 and mixes with fresh air, a pilot light is ignited and the burner 410 is activated. The heat exchanger 412 is exposed to a direct flame produced by the burner 410 and the temperature of the heat exchanger 412 increases. The blower 406 continues to direct air over the heat exchanger 412 and the temperature of the air elevates as the air absorbs heat from the heat exchanger 412. The warm air exits the combustion chamber 414 through the combustor outlet 404 and flows through the air ducts of the vehicle 200. Through the air ducts of the vehicle 200, the warm air provides cab heat to the cabin space, batteries, and other components of the vehicle 200.

In some embodiments, ambient air may be indirectly heated by a radiator rather than being directly exposed to the heat exchanger. In some embodiments, water flows through pipes in the combustion chamber 414 and is exposed to heat from the heat exchanger 412. The water becomes superheated as it absorbs heat from the heat exchanger 412 and then flows into a radiator. The blower 406 directs air over the heat exchanger 412 and exits the combustion chamber 414 through the combustor outlet 404. The warm air then flows through the air duct to the rest of the vehicle providing cab heat.

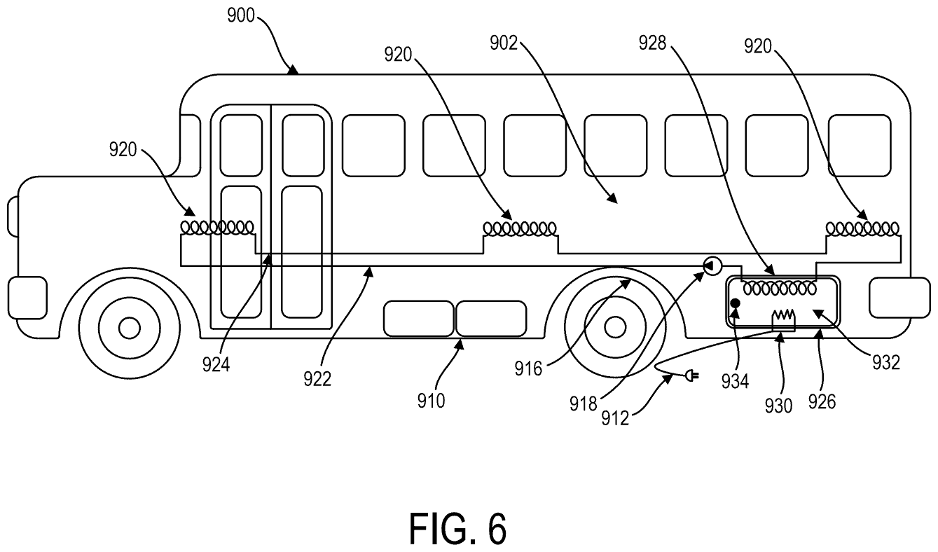

FIG. 6 is a schematic diagram of an electric vehicle with a cab heater, in accordance with another aspect of the present disclosure. Electric vehicle 900 includes batteries 910, electrical connection 912, and cabin heat system 916. When electric vehicle 900 is not in use, electrical connection 912 is used to provide electricity to replenish the energy in cabin heat system 916 and batteries 910. In the illustrated embodiment, electrical connection 912 consists of a single connection which provides electricity to cabin heat system 916 and to batteries 910. In other embodiments, electrical connection 912 may include more than one connection to provide electricity to various components of electric vehicle 910.

When electric vehicle 900 is in use, batteries 910 provide electricity to propel electric vehicle 900 while cabin heat system 916 provides heat to the cabin. Cabin heat system 916 has a charging mode and a heating mode. In the charging mode, electric vehicle 900 is not in use, and electrical connection 912 is connected to a power outlet and electricity flows into cabin heat system 916 to replenish its energy. In the heating mode, electric vehicle 900 may be in use, and cabin heat system 916 uses stored energy to provide heat to cabin 902.

Cabin heat system 916 includes fluid circulation pump 918, cabin heat exchangers 920, heat transfer tube 922, heat transfer fluid 924, and insulated tank 926. Fluid circulation pump 918 circulates heat transfer fluid 924 through heat transfer tube 922 to cabin heat exchangers 920 and insulated tank 926. In the heating mode, heat transfer fluid 924 absorbs heat from insulated tank 926 and transfers that heat to cabin heat exchangers 920. Cabin heat exchangers 920 dissipates the heat obtained from heat transfer fluid 924 to the ambient air inside cabin 902, thereby providing heat to cabin 902.

In some embodiments, cabin heat exchangers 920 include a blowers or fans which pull ambient air into cabin heat exchangers 920, such that thermal energy from heat transfer fluid 924 is easily transferred to the ambient air. Heat transfer fluid 924 may be water, glycol, refrigerant, or any other fluid suitable for transmitting energy from one point to another. Some examples of refrigerants that may be used as heat transfer fluid 924 include, but are not limited to, R134a, R1234yf, R407c, R410a, R12, and R22 refrigerants.

Insulated tank 926 converts electrical energy, provided by electrical connection 912, into latent heat energy which is stored within an insulated enclosure for later use to provide cab heat to electric vehicle 900. Insulated tank 926 includes tank heat exchanger 928, resistance heater 930, phase change material 932, and phase change sensor 934. Resistance heater 930 is thermally coupled to phase change material 932, but electrically isolated from all components besides electrical connection 912. In the charging mode, electrical connection 912 provides electricity to resistance heater 930 which converts that electricity into heat through resistance heating. The heat generated by resistance heater 930 is provided to phase change material 932. The temperature of phase change material 932 increases causing phase change material 932 to transform from one phase to another.

Phase change material 932 may be any substance which releases sufficient thermal energy during transition from a first phase to a second phase (e.g., from a gaseous form to a liquid form, from a liquid form to a solid form, or from a gaseous form to a solid form) and absorbs sufficient energy during transition from the second phase back to the first phase (e.g., from a solid form to a liquid form, from a liquid form to a gaseous form, or from a solid form to a gaseous form). These substances change phases, meaning they reversibly transform from one form to another, during a thermal cycling process. In the illustrated embodiment, the phase change material is a thermochemical material with a sufficiently high energy density. Some examples of thermochemical materials and their energy densities include, but are not limited to, TCM-81 (797 KJ/kg), TCM-71 (1442 KJ/kg), TCM-65 (535 KJ/kg), TCM-110 (587 KJ/kg), TCM-72 (1072 KJ/kg), TCM-127 (1069 KJ/kg), TCM-113 (996 KJ/kg), TCM-28 (853 KJ/kg), TCM-122 (590 KJ/kg), and TCM-250 (480 KJ/kg).

Phase change sensor 934 detects when phase change material 932 has transformed from one form to another and provides a signal to an operator of vehicle 900 that electrical connection 912 can be disconnected from a power outlet. In some embodiments, electricity may automatically stop flowing to resistance heater 930 when phase change sensor 934 detects that phase change material 932 has transformed from one form to another.

Insulated tank 926 houses phase change material 932 and prevents the dissipation of energy stored in phase change material 932. In the heating mode, fluid circulation pump 918 circulates heat transfer fluid through heat transfer tube 922 to tank heat exchanger 928. Tank heat exchanger 928 is thermally connected to phase change material 932 such that tank heat exchanger 928 absorbs heat from phase change material 932. As heat transfer fluid 924 flows through tank heat exchanger 928, transfer fluid 924 absorbs heat from heat exchanger 928. Heat transfer fluid 924 then flows out of insulated tank 926 to cabin heat exchangers 920. Cabin heat exchangers 920 absorb heat from heat transfer fluid 924 and dissipates that heat to the ambient air inside cabin 902.

Storing energy in a phase change material for later use to provide cab heat has several benefits over existing solutions. As discussed earlier, the use of a resistance heater to provide cab heat would require larger batteries to provide electricity to the resistance heater, which would increase the weight of the vehicle, the production costs, and the total cost of ownership. A phase change material, on the other hand, weighs a fraction of the weight of a battery that would provide electricity for an equivalent amount of heat. Using a fuel burner would create emissions which pollute the environment and defeat the purpose of operating an environmentally-friendly electric vehicle. Additionally, a fuel burner would increase maintenance costs because an operator would need to maintain fuel in a tank. The cabin heat system of the present invention does not create any harmful emissions and only requires that the electrical connection be plugged into an electricity outlet, which is already necessary to recharge the vehicle batteries.

Various modifications and additions may be made to the exemplary embodiments discussed without departing from the scope of the disclosed subject matter. For example, while the embodiments described above refer to particular features, the scope of this disclosure also includes embodiments having different combinations of features and embodiments that do not include all of the described features. Accordingly, the scope of the disclosed subject matter is intended to embrace all such alternatives, modifications, and variations as fall within the scope of the claims, together with all equivalents thereof.

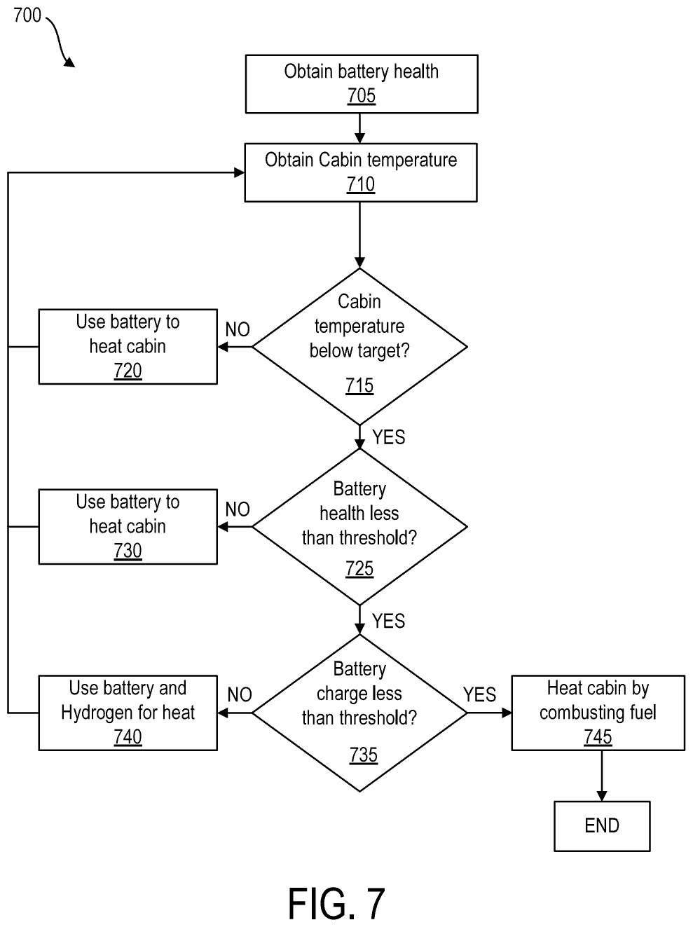

FIG. 7 is a flowchart illustrating an example method 500 for selecting a mode of providing cab heat, in accordance with embodiments of the present disclosure. Method 500 may be performed automatically (e.g., autonomously) by vehicle cab heater 510, FIG. 2. In operation 505, the vehicle cab heater obtains the battery state-of-charge. The battery state-of-charge may include data corresponding to one or more indications of the batteries capacity to deliver power to the vehicle 300. For example, in some embodiments, the battery state-of-charge may include the age of the batteries. In operation 510, the vehicle cab heater obtains the cabin temperature. The cabin temperature may include information about different temperature sensors dispersed at various locations within the cabin. For example, in some embodiments, the cabin temperature may include an array of numbers corresponding to the different localized temperatures within the cabin of the vehicle 300 and the temperature of the batteries and other accessories which operate at an optimal temperature. In some embodiments, this array of numbers may include information such as the temperature of a battery, vehicle location and ambient condition information, information from sensors such as smoke detectors and gas sensors of the vehicle, information from vision systems of the vehicle, (e.g., cameras, LIDAR, RADAR), information from one or more of the vehicle's subsystems, information from the vehicle's powertrain, etc. In some embodiments, the vehicle cab heater may obtain cabin temperature data from a virtual sensor, such as a model, or computer algorithm, configured to approximate a temperature based on information about the vehicle. In some embodiments, the vehicle cab heater may obtain cabin temperature data from physical sensors on the vehicle.

In operation 515, the vehicle cab heater determines, by comparing the cabin temperature to the target temperature threshold, whether the cabin temperature is below the target temperature threshold. In response to determining that the target temperature threshold is below the target temperature threshold, the vehicle cab heater proceeds to operation 535. Alternatively, in response to determining that the target temperature threshold is exceeded, the vehicle cab heater proceeds to operation 525 and continues to draw moderate amounts of energy from the battery to maintain the cabin temperature at, or above, the temperature threshold.

In operation 535, the vehicle cab heater determines, by comparing the battery state-of-charge to the state-of-charge threshold, whether the battery state-of-charge is below the state-of-charge threshold. In response to determining that the battery state-of-charge is below the state-of-charge threshold, the vehicle cab heater proceeds to operation 540, where it initiates the combustion of hydrogen to provide cab heat. Alternatively, in response to determining that the battery state-of-charge is above the state-of-charge threshold, the vehicle cab heater proceeds to operation 545, where it draws energy from the battery to provide cab heat using the electric heater.

To further illustrate embodiments of the present disclosure, the following is an example performance of method 500 by the vehicle cab heater. In operation 505, a vehicle cab heater of a vehicle obtains the battery state-of-charge indicating that the battery state-of-charge is approximately 80%. In operation 510, the vehicle cab heater obtains cabin temperature data indicating that the cabin temperature is approximately 60° F. In operation 515, the vehicle cab heater determines, by comparing the cabin temperature (i.e., 60° F.) to the target temperature threshold (e.g., 68° F.), that the cabin temperature is below the target temperature threshold. In response to the determination in operation 515, the vehicle cab heater proceeds to operation 535. In operation 535, the vehicle cab heater may determine, by comparing the battery state-of-charge (i.e., 80%) to the battery state-of-charge threshold (e.g., 85%), that the battery state-of-charge is below the threshold. In response to the determination in operation 535, the vehicle cab heater may proceed to operation 540 and activate the hydrogen combustor to provide additional cab heat.

FIG. 8 is a block diagram depicting an illustrative computing device 600, in accordance with embodiments of the disclosure. The computing device 600 may include any type of computing device suitable for implementing aspects of embodiments of the disclosed subject matter. Each of the various components shown and described in the Figures may contain their own dedicated set of computing device components, such as those shown in FIG. 2 and described below.

In embodiments, the computing device 600 includes a bus 610 that, directly and/or indirectly, couples one or more of the following devices: a processor 620, a memory 630, an input/output (I/O) port 640, an I/O component 650, and a computing device power supply 660. Any number of additional components, different components, and/or combinations of components may also be included in the computing device 600.

The bus 610 represents what may be one or more busses (such as, for example, an address bus, data bus, or combination thereof). Similarly, in embodiments, the computing device 600 may include a number of processors 620, a number of memory components 630, a number of I/O ports 640, a number of I/O components 650, and/or a number of power supplies 660. Additionally, any number of these components, or combinations thereof, may be distributed and/or duplicated across a number of computing devices.

In embodiments, the memory 630 includes computer-readable media in the form of volatile and/or nonvolatile memory and may be removable, nonremovable, or a combination thereof. Media examples include random access memory (RAM); read only memory (ROM); electronically erasable programmable read only memory (EEPROM); flash memory; optical or holographic media; magnetic cassettes, magnetic tape, magnetic disk storage or other magnetic storage devices; data transmissions; and/or any other medium that may be used to store information and may be accessed by a computing device. In embodiments, the memory 630 stores computer-executable instructions 670 for causing the processor 620 to implement aspects of embodiments of components discussed herein and/or to perform aspects of embodiments of methods and procedures discussed herein. The memory 630 may comprise a non-transitory computer readable medium storing the computer-executable instructions 670.

The computer-executable instructions 670 may include, for example, computer code, machine-useable instructions, and the like such as, for example, program components capable of being executed by one or more processors 620 (e.g., microprocessors) associated with the computing device 600. Program components may be programmed using any number of different programming environments, including various languages, development kits, frameworks, and/or the like. Some, or all, of the functionality contemplated herein may also, or alternatively, be implemented in hardware and/or firmware.

According to embodiments, for example, the instructions 670 may be configured to be executed by the processor 620 and, upon execution, to cause the processor 620 to perform certain processes. In certain embodiments, the processor 620, memory 630, and instructions 670 are part of a controller such as an application specific integrated circuit (ASIC), field-programmable gate array (FPGA), and/or the like. Such devices may be used to carry out the functions and steps described herein.

The I/O component 650 may include a presentation component configured to present information to a user such as, for example, a display device, a speaker, and/or the like, and/or an input component such as, for example, a microphone, a wireless device, a keyboard, a voice input device, a touch input device, a touch-screen device, an interactive display device, a mouse, and/or the like.

The devices and systems described herein may be communicatively coupled via a network, which may include a controller area network (CAN), local area network (LAN), a wide area network (WAN), a cellular data network, via the internet using an internet service provider, and the like.

Aspects of the present disclosure are described with reference to flowchart illustrations and/or block diagrams of methods, devices, systems and computer program products. It will be understood that each block of the flowchart illustrations and/or block diagrams, and combinations of blocks in the flowchart illustrations and/or block diagrams, may be implemented by computer program instructions.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.”

Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

Systems, methods and apparatus are provided herein. In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic with the benefit of this disclosure in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. § 112 (f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A hydrogen combustor for providing cab heat to an electric vehicle, the hydrogen combustor comprising:
a combustion chamber configured to be mounted to an electric vehicle, the combustion chamber having a combustor inlet and a combustor outlet; and
a hydrogen storage fluidly coupled to the combustor inlet and configured to supply hydrogen to the combustor for combustion.

2. The hydrogen combustor of claim 1, further comprising a burner for igniting the hydrogen within the combustion chamber to produce heat.

3. The hydrogen combustor of claim 2, further comprising a heat exchanger, wherein the heat produced by combusting hydrogen is transferred to a quantity of air via said heat exchanger.

4. The hydrogen combustor of claim 3, further comprising a blower, wherein said blower draws air into the combustion chamber through the combustor inlet to facilitate the transfer of heat from the heat exchanger to said quantity of air.

5. The hydrogen combustor of claim 3, wherein the heat exchanger comprises a plurality of fins or baffles for increasing the surface area available for heat transfer.

6. The hydrogen combustor of claim 2, further comprising a radiator having a liquid flowing through the coils of said radiator,
wherein the heat produced by combusting hydrogen is transferred to the liquid flowing through the coils of the radiator, and
wherein a quantity of air absorbs said heat from the liquid flowing through the radiator coils.

7. A system for providing cab heat to an electric vehicle, the system comprising:
a fan;
an electric heater positioned downstream from the fan;
a vehicle battery to provide power to the electric heater and the fan; and
a hydrogen combustor positioned downstream from the fan, including:
a combustion chamber having a combustor inlet and a combustor outlet;
a hydrogen storage fluidly coupled to the combustor inlet and configured to supply hydrogen to the combustor for combustion; and
a burner for igniting the hydrogen within the combustion chamber to produce heat.

8. The system of claim 7, further comprising a hydrogen supply line for supplying hydrogen from the hydrogen storage tank to the combustion chamber.

9. The system of claim 7, further comprising a heat exchanger for transferring heat from the hydrogen combustion to the air.

10. The system of claim 7, further comprising a radiator having a liquid flowing through the coils of said radiator, wherein the heat produced by combusting hydrogen is transferred to the liquid flowing through the coils of the radiator, and
wherein a quantity of air absorbs said heat from the liquid flowing through the radiator coils.

11. The system of claim 7, further comprising a controller configured to deactivate the hydrogen combustor when the cabin temperature reaches a predetermined threshold.

12. The system of claim 7, further comprising a controller to regulate the rate of hydrogen combustion and the flow rate of air through the heat exchanger to maintain a desired cabin temperature.

13. The system of claim 7, wherein the combustor and heat exchanger are integrated into a single unit for compactness and ease of installation.

14. The system of claim 7, wherein the hydrogen is stored in a high-pressure tank or a solid-state hydrogen storage material.

15. A system for providing heat to the cabin of an electric vehicle, the system comprising:
a fluid circulation pump;
one or more cabin heat exchangers;
a heat transfer tube fluidly connected to the fluid circulation pump and to the one or more cabin heat exchangers; and
an insulated tank comprising:
a tank heat exchanger fluidly connected to the heat transfer tube;
a resistance heater; and
a phase change material;
wherein in a charging mode, the resistance heater provides heat to the phase change material and to the tank heat exchanger; and
wherein in a heating mode, the fluid circulation pump circulates a heat transfer fluid through the heat transfer tube to the tank heat exchanger, where heat from the tank heat exchanger is absorbed by the heat transfer fluid, and to the one or more cabin heat exchangers, where heat from the heat transfer fluid is absorbed by ambient air in the cabin.

16. The system of claim 15, further comprising one or more batteries and an electrical connection, wherein the electrical connection provides electricity to the resistance heater and to the batteries.

17. The system of claim 16, wherein the insulated tank further comprises a sensor for detecting when the phase change material changes from a first phase to a second phase, and wherein the electrical connection automatically stops the flow of electricity to the resistance heater when the phase change material changes from the first phase to the second phase.

18. The system of claim 15, wherein the one or more cabin heat exchangers include blowers for drawing ambient air into the one or more cabin heat exchangers, so as to maximize the transfer of thermal energy from the heat transfer fluid to the ambient air.

19. The system of claim 15, wherein the heat transfer fluid is selected from a group consisting of water, glycol, and refrigerant.

20. The system of claim 15, wherein the phase change material is a thermochemical material.
